(19) United States
(12) Patent Application Publication
(10) Pub. No.: US 2009/0094091 A1
(43) Pub. Date: Apr. 9, 2009

(54) SERVICE CALL DATA SELECTION AND DELIVERY METHOD AND SYSTEM

(75) Inventors: Tracy Eugene Thieret, Webster, NY (US); Carl Gerald Nielsen, Ontario, NY (US); Robert Allen Gunther, Webster, NY (US); James Gregg Bullen, Caledonia, NY (US); Connie Treese Gaylord, Mumford, NY (US); Darrell Lynn Rublee, Pittsford, NY (US); John Anthony Valentino, Rochester, NY (US)

Correspondence Address: PEPPER HAMILTON LLP, 500 GRANT STREET, ONE MELLON CENTER, 50TH FLOOR, PITTSBURGH, PA, 15219, US

(73) Assignee: Xerox Corporation, Stamford, CT (US)

(21) Appl. No.: 11/868,212

(22) Filed: Oct. 5, 2007

(51) Int. Cl. G06Q 10/00; G06F 13/00; G06F 9/46

(52) U.S. Cl. 705/9

(57) ABSTRACT

A method of dispatching a service call for an electromechanical device, such as a document production device, is disclosed. The method includes receiving, by a dispatching server, a communication requesting service on a first document production device. The communication includes a unique identifier corresponding to the first device. A data server stores operational history data for a multiple document production devices, and the dispatching server accesses the operational history data in the data server to retrieve service data for the first device. The dispatching service sends a service order message to a customer service representative mobile communication device. The service order message includes a location identifier for the first device, operator contact information for the first device, and the service data.

### BACKGROUND

The disclosure contained herein generally relates to methods and systems for providing dispatching service technicians to service equipment located in various locations. In a particular embodiment the disclosure relates to methods and systems that enable document processing technicians to receive relevant, device-specific information when they are dispatched to service a maintenance issue on a document processing device.

Diagnosis and repair of complex electromechanical devices, such as document processing devices, requires sophisticated techniques and highly trained service technicians. Additionally, the current service process for diagnosis and repair of these electromechanical devices can require significant device downtime, leading to reduced productivity.

When a service technician is dispatched to provide service on a device, the information that they get relating to the device is often minimal. In many cases, the technician must rely on information that the customer has supplied over the phone, and sometimes a technician arrives without required replacement parts because the customer either mis-described the problem or did not know about a particular issue that would have prompted the technician to obtain the replacement part before leaving the technician's shop. This leads to additional device downtime and service costs

Accordingly, what is needed is a system and method to improve the dispatching of service calls for complex electromechanical devices. The disclosure contained herein describes solutions to one or more of the problems described above.

### SUMMARY

In an embodiment, a method of dispatching a service call for a document production device includes receiving, by a dispatching server, a communication requesting service on a first document production device, wherein the communication includes a unique identifier corresponding to the first device. The method accesses a data server which stores operational history data for multiple document production devices; retrieves, from the operational history data in the data server, service data for the first device; and dispatches, to a customer service representative mobile communication device, a service order message. The service order message includes a location identifier for the first device, operator contact information for the first device, and the service data. The accessing may include running, by the dispatching server, a script to command the data server to send the service data to the dispatching server. Optionally, the method also may include contacting, by an operator of the mobile communication device, an operator of the document production device to provide the service from a remote location. Also optionally, before the receiving, the method may include accepting, by a call center, a service call from an operator of the document production device; attempting, by the call center, to resolve the service call; and only performing the dispatching if the call center is unable to resolve the service call.

The service data may, in some embodiments, include a set of recent fault codes for the first device, and the accessing comprises commanding the data server to select, from the operational history data, the set of recent fault codes for the first device. In addition or alternatively, the service data may include a current software version for each of various components of the first device, and the accessing may include commanding the data server to select, from the operational history data, the current software versions. As an additional option, the service data may include a current configuration for each of various components of the first device, and the accessing may include commanding the data server to select, from the operational history data, the current configurations. As yet another option, the service data may include an indication of whether routine maintenance is due for each of various consumable components of the first device, and the accessing may include commanding the data server to select, from the operational history data, the indications.

In some embodiments, the service order message includes at least two alerts. In this embodiment, the dispatching includes sending a first alert with a location identifier for the first device and operator contact information for the first devices and sending a second alert that includes the service data, wherein the second alert is presented in a format that is common to all service data alerts and which is distinguishable from non-service data alerts. Alternatively, the service order message may be in the form of an encoded file containing the service data and corresponding codes that enable a third party to reformat the service data for delivery to a plurality of mobile communication device types. In some embodiments, the dispatching includes including the service data in the service order message without manipulating values received from the data server.

In an alternate embodiment, a method of dispatching an electromechanical device service call includes receiving, by a dispatching server, a communication requesting service on a first electromechanical device. The communication may include a unique identifier corresponding to the first device. The method may include accessing a data server which stores operational history data for various electromechanical devices to select a set of recent fault codes for the first device and a current software version for the first device. The method also may include dispatching, to a customer service representative mobile communication device, a service order message. The service order message may include a location identifier for the first device, operator contact information for the first device, the selected set of recent fault codes for the first device, and the current software version for the first device. Optionally, the accessing may include selecting a configuration for each of a plurality of components of the first device, and the service order message may include the selected configurations. The accessing also may include selecting an indication of whether routine maintenance is due for each of various consumable components of the first device, and the service order message may include the selected indications.

In an alternate embodiment, a document processing device service dispatching system includes a call center that receives service calls from multiple document processing device operators, a data server that stores operational history data for multiple document processing devices, and a dispatching server. When the dispatching server receives a command from the call center, the dispatching server: (i) obtains operational history data for a document processing device from the data server; and (ii) generates a service order message containing the operational history data, a location identifier for the device, and operator contact information for the device, and sends a service order message to a service technician mobile device.

### BRIEF DESCRIPTION OF THE SEVERAL VIEWS OF THE DRAWINGS

FIG. 1 depicts a high level system diagram according to an embodiment.

FIG. 2 shows an exemplary mobile communication device and a display screen showing exemplary categories of information that may be included in a service order transmitted to the mobile device.

FIG. 3 illustrates exemplary operational history data screens that may be displayed on a customer service representative's mobile communication device.

FIG. 4 depicts an exemplary flow diagram for a process of automatically preparing and sending a service order for remote diagnosis and repair of an electromechanical device.

### DETAILED DESCRIPTION

Before the present methods, systems and materials are described, it is to be understood that this disclosure is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the”>include plural reference unless the context clearly dictates otherwise. As used herein, the term “comprising” means “including, but not limited to.”

As used herein, the terms “document processing device” and “print device” are used interchangeably to refer to a device that performs a document processing function in a document production environment using any printing technology, such as xerography, ink-et, or offset; a document scanner or specialized reader such as a check reader; mail handling machine; fabric or wallpaper printer; or any device in which an image of any kind is created on and/or read from a moving substrate. A document processing device may include, but is not limited to, a printer, copier, scanner, facsimile machine, document finishing device such as a binder, another document processing device. A printer is an electronic device that is capable of receiving commands and printing text and/or images on a substrate. Printing devices may also perform a combination of functions such as printing/scanning copying/faxing, in which case such devices may be considered to be multifunctional devices.

This disclosure is generally related to providing an automated or partially automated system and method for remote or partially remote diagnosis and potential repair of any electromechanical device which is on a computer network or is capable of being added to a computer network.

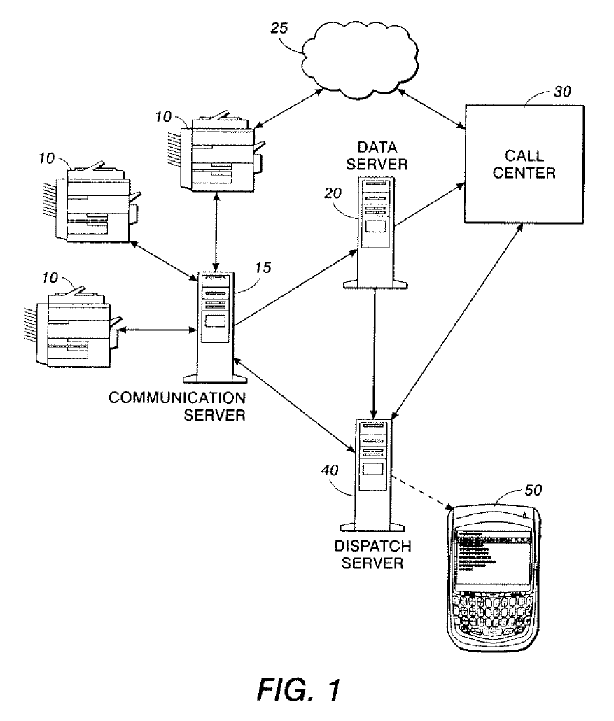

FIG. 1 illustrates exemplary components of a service call data delivery system. Any number of document production devices 10 are in communication with one or more communication servers 15 that collect operational history data from the document production devices 10 and relay that data to a remote data server 20. Each communication server may communicate with its corresponding devices within an internal network. The internal network may include, but is not limited to, a local area network (LAN), a wide area network (WAN), the Internet or another communications network, such as a wireless or wired network.

Each communication server 15 may periodically execute commands to collect operational history data from its corresponding document production devices 10 by polling the document production devices 10. Alternatively, the document production devices 10 may push operational history data to a communication server 15 in a manner that is continuous, periodic, or responsive to one or more actions at the document production device 10. Examples of operational data that a print device 10 may transmit to a communication server 15 may include: age of the device; status information; one or more fault codes that indicate an actual or potential maintenance requirement for the device; a configuration reflecting individual components that are included as part of the device; a software type and version for the device or its individual components; a time of the last status check; a machine running time; an indication of whether routine maintenance is due for a consumable component; a measurement of time or usage since an individual component (such as a photoreceptor, toner cartridge, pressure roll, or other component) was last installed, cleaned or otherwise serviced; or a measurement of toner weight.

Optionally, the document processing devices 10 or their operators may also communicate with a call center 30 via a communications network 25. The communication may be voice communication facsimile, electronic mail or messaging, or other communication by which a device operator may request service from the call center. The call center may include a group of technicians who can communicate with document processing device operators to attempt to resolve a service issue by telephone, electronic mail or messaging, or another communications mechanism.

If the call center is unable to resolve an issue, it may initiate a request that a dispatch server 40 send a customer service representative such as an engineer or technician, to a location of the print device for which the service call was initiated. The dispatch server 40 may then transmit a service order to a mobile communication device 50 so that the representative who uses the device can respond to the service order. The mobile communication device 50 is any device that can receive an electronic communication and enable a user to selectively display data that is included in the communication. Examples of suitable mobile communication devices include, and are not limited to, personal digital assistants; laptops with wireless communication and electronic mail or browser client capability; global positioning systems with displays; mobile phones with display screens; and other mobile communication and display devices.

In embodiments described herein, the service order includes information that enables the service technician to diagnose at least a portion of the service issue before visiting the device location. The dispatch server 40 will obtain this information from the data server 20 so that the service technician has the most current data that is available for the device in question.

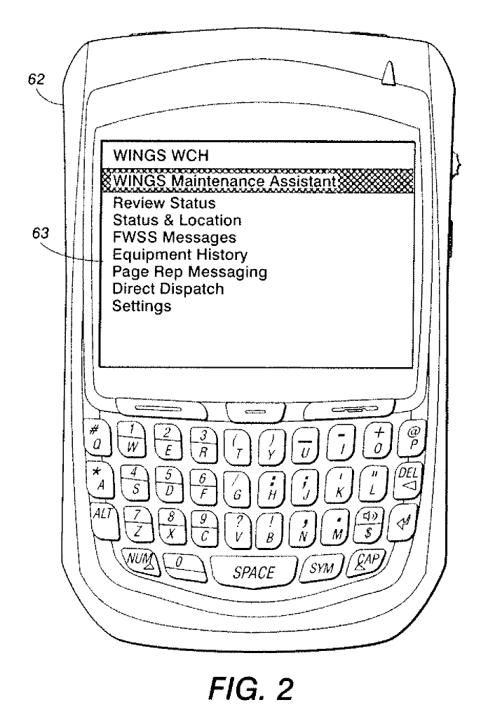

FIG. 2 indicates exemplary categories of information that may be included in a service order transmitted to a mobile device 50. For example, the data may include location and contact information 63 for the device in question, and it also may include operational history data 61.

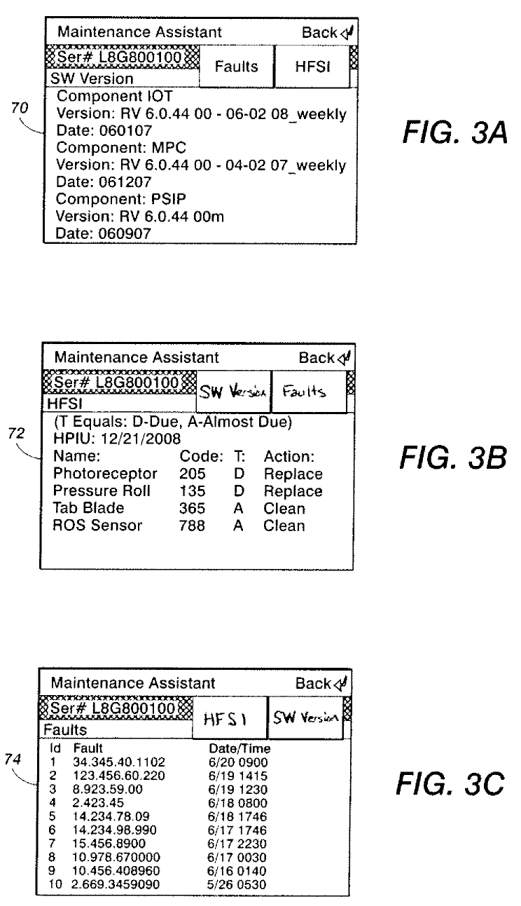

FIG. 3 illustrates exemplary operational history data screens that may be displayed on the mobile device. For example, a software version data screen 70 showing software versions installed within various components of the device may indicate a version number and/or revision date of the software installed on various components. The technician can use this screen to identify whether any incompatible software versions may be installed, indicating that a software update on one or more components may resolve the problem. A high frequency service item (HFSI) screen 72 may display status information about device components that require periodic maintenance based on usage, such as photoreceptors, pressure rolls, blades, sensors, toner cartridges, or other items that may require service or replacement after a period of time or level of usage. The technician can use this screen to identify whether or not to bring a replacement component, cleaning equipment, or other relevant service items to the job site. A fault code screen 74 may display a set of recent fault codes, such as all fault codes that the device transmitted within a predetermined or user-selectable time period, or a predetermined or user-selectable number of most recent fault codes. The technician can use this screen to help identify device faults and diagnose device problems before visiting the job site.

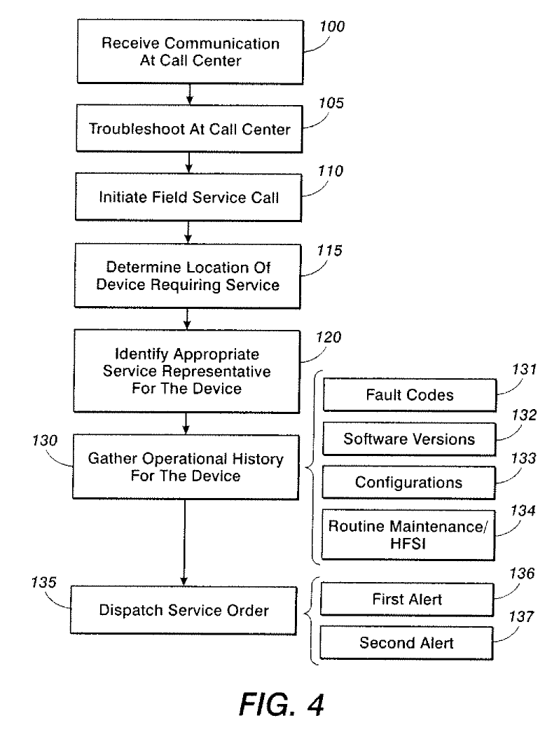

FIG. 4 is a flow diagram that illustrates exemplary steps in a process of automatically preparing and sending a service order for remote diagnosis and repair of an electromechanical device. Referring to FIG. 4, a call center may receive 100 a communication from an electromechanical device or the device's operator. The communication may be a phone call, an electronic message, or anther communication by which the device or its operator requests service for the device. A call center operator may attempt to troubleshoot 105 the problem via phone, email, text messaging or other communication. If troubleshooting does not resolve the issue, or optionally if the call center is bypassed or unavailable, a command may be sent 110 to initiate a field service call on the device. The command may include a unique identifier of the electromechanical device, such as a serial number or internet protocol address.

A dispatching server may receive the command and determine a location 115 of the electromechanical device based on the device's unique identifier. The dispatching server also has access to data indicative of locations of multiple customer service representatives (CSRs), such as field technicians or engineers, and the data may be gathered from mobile communication devices and global positioning system data or other location-based communications.

Based on the device location and CSR locations, the dispatching server may identify 120 a CSR who is in geographic proximity to the device. Geographic proximity may be determined based on distance from the device, population or traffic density, and/or other information. The selection of the CSR also may consider other service in each CSR's queue to determine and select a CSR within a given proximity who has the capacity to handle the additional service order

In addition, the dispatching server may gather 130 service data for the device from a data server that stores operational history data for the device and other devices. The gathering may be performed by running a script that commands the data server to send the service data to the dispatching server. The command may require the data server to select, from the operational history data, data including but not limited to any or all of the following: recent fault codes 131 for the device; current software configurations 132 for various components within the device; current component configurations 133 within the device; and/or the status of various high frequency service items within the device, such as indications of whether routine maintenance is due for consumable components 134.

The dispatching server may dispatch 135 the service order by transmitting the service order to a mobile communication device of the CSR via electronic communication. The dispatching may include a text message or other type of message. In other embodiments, the dispatching may include a first alert 136 that includes device identifier and contact information, and a second alert 137 that includes the service data. When separate alerts are provided, the second alert is preferably provided in a format that is common to second alerts (such as by presenting the text in a different font or color) so that second alerts may be distinguished from first alerts on a CSE's mobile device. In some embodiments, the service data may be included in the service order message in “raw” form, without modification or manipulation of the values. However, such raw form does not preclude reformatting to meet communication standards. In some embodiments, the service order message may be sent as an encoded file to a different communications server that can reformat the service data to be delivered to multiple types of electronic communications devices.

Optionally, the CSE may then contact 140 an operator of the electromechanical device for which service is requested and use the service data to attempt to provide service from a remote location via telephone or other communication methods.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method of dispatching a service call for a document production device, comprising:
receiving, by a dispatching server, a communication requesting service on a first document production device, wherein the communication includes a unique identifier corresponding to the first device;
accessing a data server which stores operational history data for a plurality of document production devices;
retrieving, from the operational history data in the data server, service data for the first device; and
dispatching, to a customer service representative mobile communication device, a service order message, the service order message comprising a location identifier for the first device, operator contact information for the first device, and the service data.

2. The method of claim 1, wherein the accessing comprises running, by the dispatching server, a script to command the data server to send the service data to the dispatching server.

3. The method of claim 2, wherein the service data comprises a set of recent fault codes for the first device, and the accessing comprises commanding the data server to select, from the operational history data, the set of recent fault codes for the first device.

4. The method of claim 2, wherein the service data comprises a current software version for each of a plurality of components of the first device, and the accessing comprises commanding the data server to select, from the operational history data, the current software versions.

5. The method of claim 2, wherein the service data comprises a current configuration for each of a plurality of components of the first device, and the accessing comprises commanding the data server to select, from the operational history data, the current configurations.

6. The method of claim 2, wherein the service data comprises an indication of whether routine maintenance is due for each of a plurality of consumable components of the first device, and the accessing comprises commanding the data server to select, from the operational history data, the indications.

7. The method of claim 1, further comprising:
contacting, by an operator of the mobile communication device, an operator of the document production device to provide the service from a remote location.

8. The method of claim 1, wherein the service order message comprises a plurality of alerts, and the dispatching comprises:
sending, in a first alert; a location identifier for the first device and operator contact information for the first device; and
sending, in a second alert, the service data, wherein the second alert is presented in a format that is common to all service data alerts and which is distinguishable from non-service data alerts.

9. The method of claim 1, wherein the service order message comprises an encoded file containing the service data and corresponding codes that enable a third party to reformat the service data for delivery to a plurality of mobile communication device types.

10. The method of claim 1, wherein the dispatching comprises including the service data in the service order message without manipulating values received from the data server.

11. The method of claim 1, further comprising, before the receiving:
accepting, by a call center, a service call from an operator of the document production device;
attempting, by the call center, to resolve the service call; and
only performing the dispatching if the call center is unable to resolve the service call.

12. A method of dispatching an electromechanical device service call, comprising:
receiving, by a dispatching server, a communication requesting service on a first electromechanical device, wherein the communication includes a unique identifier corresponding to the first device;
accessing a data server which stores operational history data for a plurality of electromechanical devices to select a set of recent fault codes for the first device and a current software version for the first device;
dispatching, to a customer service representative mobile communication device, a service order message, the service order message comprising a location identifier for the first device, operator contact information for the first device, the selected set of recent fault codes for the first device, and the current software version for the first device.

13. The method of claim 12, wherein:
the accessing further comprises selecting a configuration for each of a plurality of components of the first device, and
the service order message further comprises the selected configurations.

14. The method of claim 12, wherein:
the accessing further comprises selecting an indication of whether routine maintenance is due for each of a plurality of consumable components of the first device, and the service order message further comprises the selected indications.

15. The method of claim 12, further comprising:
contacting, by an operator of the mobile communication device using data from the service order message, an operator of the document production device to provide the service from a remote location.

16. The method of claim 12, wherein the service order message comprises a plurality of alerts, and the dispatching comprises:
sending, in a first alert; a location identifier for the first device and operator contact information for the first device; and
sending, in a second alert, the service data, wherein the second alert is presented in a format that is common to other service data alerts and which is distinguishable from non-service data alerts.

17. The method of claim 12, wherein the service order message comprises an encoded file containing the service data and corresponding codes that enable a third party to reformat the service data for delivery to a plurality of mobile communication device types.

18. The method of claim 12, wherein the dispatching comprises including the service data in the service order message without manipulating values received from the data server.

19. The method of claim 12, further comprising:
accepting, by a call center, a service call from an operator of the document production device;
attempting, by the call center, to resolve the service call;
selecting, based on the location identifier of the first device and a detected location of the customer service representative mobile communication device, the customer service representative mobile communication device, and
only performing the dispatching if the call center is unable to resolve the service call.

20. A document processing device service dispatching system, comprising:
a call center that receives service calls from a plurality of document processing device operators;
a data server that stores operational history data for a plurality of document processing devices;
a dispatching server that in response to a command from the call center:
obtains operational history data for a document processing device from the data server,
generates a service order message containing the operational history data, a location identifier for the device, and operator contact information for the device, and
sends a service order message to a service technician mobile device.
